(19) United States
(12) Patent Application Publication
(10) Pub. No.: US 2006/0243118 A1
(43) Pub. Date: Nov. 2, 2006

(54) Drumstick with retractable and replaceable tip

(76) Inventor: Alan E. Malott, Winslow, AZ (US)

Correspondence Address: ETHERTON LAW GROUP, LLC, 5555 E. VAN BUREN STREET, SUITE 100, PHOENIX, AZ, 85008, US

(21) Appl. No.: 11/115,718

(22) Filed: Apr. 27, 2005

(51) Int. Cl. G10D 13/02

(52) U.S. Cl. 84/422.4

(57) ABSTRACT

An improved drumstick with a retractable tip is disclosed. The drumstick comprises a hollow body with a tip that is capable of being retracted into the hollow body when struck against a drum or other surface. The tip rests in a retainer cup that contacts a spring which is adjusted by a screw. The drumstick produces sound at lower tones when the tip is retracted within the hollow body and higher tones when the tip is extended. When retracted within the hollow body, the drumstick produces a double echo when struck against a drum.

### FIELD OF INVENTION

This invention relates to a drumstick used to strike a drum or other surface to produce an audible sound. This invention particularly relates to a drumstick with a tip that can retract into the body of the drumstick to alter the sound produced when the drumstick strikes a surface.

### BACKGROUND

A drum is a body with a striking surface, usually plastic or animal skin stretched across a frame and secured to it with a set of screws or other fasteners. Other drums, such as steel drums, lack the skin and the striking surface is part of the body. Drums produce sounds at various tones when drumsticks strike the striking surface. These tones range from high to low and can vary based on numerous factors including the size of the drum and drumstick.

There are several ways to raise or lower the tone produced. A drummer can alter the tension of the skin or replace one skin with a different type. A tighter skin will produce a higher tone than a looser skin. Besides altering the tension of the skin or changing the type of skin used, the drummer can alter the sound produced by a particular drum by using different drumsticks, as certain drumsticks produce different sounds than others. For example, longer, thinner drumsticks will produce a different tone than shorter, wider drumsticks.

Unfortunately, adjusting a drum's skin during a performance is difficult and very impractical since the old skin must be removed from the frame before a new skin can be secured to the frame. Tightening or loosening the skin requires that several screws (or other fasteners) securing the skin to the frame be individually adjusted. While a drummer can change drumsticks during a performance, he still must stop playing the drum, put down the drumsticks and pick up a different set of drumsticks. In the midst of a musical performance, this can be interruptive to the drummer.

Even if a musician can change the particular sound produced by a drum, the drummer can only produce sounds at one particular tone at a time and cannot produce two different tones with two successive strikes of the drumstick to the drum. Additionally, traditional drums are incapable of producing any type of double echo effect with a single strike of the drumstick to the skin.

Therefore, it is an object of the present invention to provide an improved drumstick for use with a drum to produce both high and low tones without having to change the drum skin or the drumstick. It is a further object of the invention to produce a drumstick that can produce a high tone with one strike of the drumstick to the drum and immediately produce a lower tone upon the second successive strike of the drumstick. It is also an object of the present invention to provide a drumstick capable of producing a double echo.

### SUMMARY OF THE INVENTION

The present invention is a drumstick that can be adjusted to produce sounds of various tones in both high and low ranges; produce both high and low toned sounds with successive strikes; and produce a double echo. The drumstick has a spring-mounted tip supported by a retainer cup that is able to retract within a hollow body defined by the drumstick. The spring forces the tip out of the hollow body until the drumstick strikes a surface with sufficient counterforce to drive the tip back into the body. If the drummer strikes the drumstick against the drum a second time while the tip is still retracted within the body, the sound produced by the second strike will be at a lower tone than the sound produced by the first strike. Additionally, striking the drumstick against the drum when the tip is in a retracted position produces a double echo. The drumstick can optionally include an adjustment screw to adjust the tension on the spring, thereby altering the amount of force applied to the tip and altering the sound produced by the drumstick.

### BRIEF DESCRIPTION OF THE DRAWINGS

FIG. 1 is a side view of the drumstick with the tip fully extended;

FIG. 2 is a perspective view of the drumstick striking a drum forcing the tip to retract within the hollow body of the drumstick;

FIG. 3a is a close-up, cross-sectional view of the distal end of the drumstick with the tip fully extended;

FIG. 3b is a close-up, cross-sectional view of the distal end of the drumstick with the tip retracted;

FIG. 4 is a perspective view of the proximate end of the drumstick; and

FIG. 5 is a close-up cross-sectional view of the distal end of the drumstick in an alternative embodiment of the present invention.

### DETAILED DESCRIPTION OF THE INVENTION

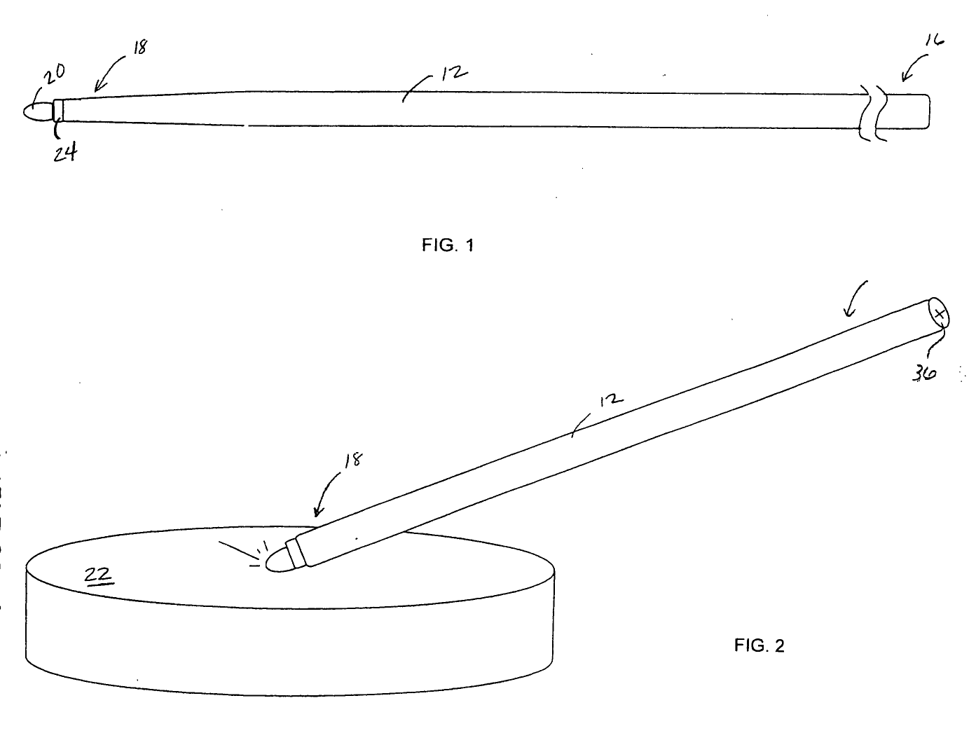

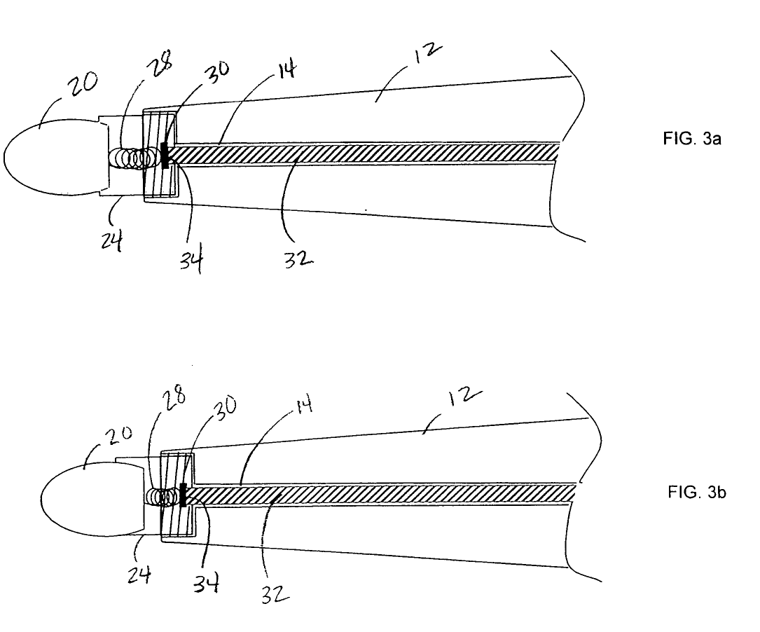

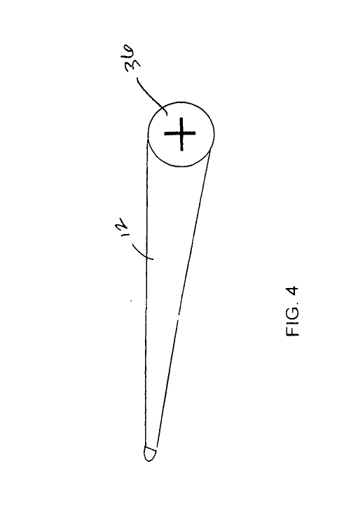

The present invention is an improved drumstick with a spring mounted tip that produces sounds at different tones upon sequential strikes and a double echo. In the preferred embodiment, as shown in FIGS. 1-4, the drumstick comprises a hollow body 12 that defines a cavity 14. Body 12 includes a proximate end 16 that is held in the user's hand and a distal end 18 with a tip 20 that is used to strike a surface 22 such as a drum.

Distal end 18 comprises a removable hollow fitting 24 which can be screwed onto body 12 to become an extension of cavity 14. In that regard, hollow fitting 24 and tip 20 can be easily replaced in this embodiment. In alternative embodiments where it is not desirable to remove the fitting, hollow fitting 24 can be an integral part of body 12. Hollow fitting 24 defines an opening through which the tip 20 protrudes into an extended position as shown in FIGS. 1 and 3a. When tip 20 is in the extended position, the drumstick produces sound at a higher tone than when tip 20 is in a retracted position as shown in FIG. 3b. Greater base tones are produced when tip 20 is in the retracted position. Tip 20 is supported by a spring 28 which enables tip 20 to move from the retracted position to the extended position.

As shown in FIGS. 3a and 3b, spring 28 is located within hollow fitting 24 and provides enough tension to force tip 20 out of the opening until the tip 20 strikes the drum surface 22 with enough counterforce to push tip 20 back into cavity 14. When the counterforce is removed, spring 28 pushes tip 20 back through the opening. But, tip 20 will remain in the retracted position for a brief moment after tip 20 has been pushed into cavity 14 until spring 28 can react with sufficient force to push tip 20 back through the opening. Therefore, striking the drumstick against drum surface 22 twice in rapid succession results in a first tone (when tip 20 is extended and actually contacts drum surface 22) that is higher than the second tone (when tip 20 is retracted within cavity 14).

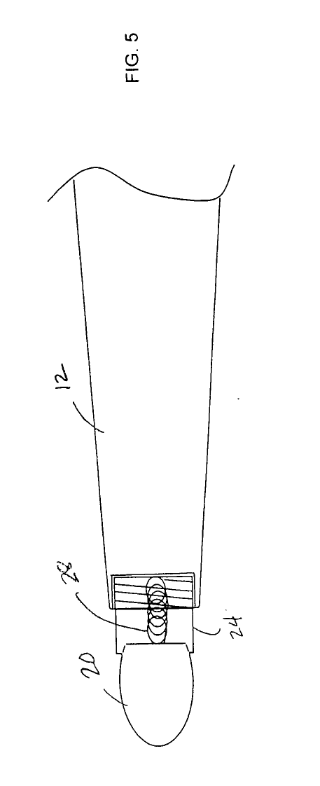

In the preferred embodiment, spring 28 is supported by a retainer cup 30 is in contact with an adjustor such as a screw 32 that can adjust the amount of force placed on the spring 28. Retainer cup 30 preferably rests within the hollow fitting 24 that is an extension of cavity 14 and maintains the spring 28 in proper position relative to the screw 32, thereby preventing the spring 28 from getting wound around the screw 32. In the preferred embodiment, spring 28 is directly connected to retainer cup 30. However, it is contemplated that alternate structures can be used in place of retainer cup 30 to maintain spring 28 in proper position relative to the screw 32, and that such alternate structures do not necessarily require that the spring 28 be attached to the retainer cup 30. For example, in an alternative embodiment shown in FIG. 5, screw 32, cavity 14, and retainer cup 30 are eliminated and the spring is in contact with the back portion of hollow fitting 24.

Screw 32 is threadably engaged along the entire length of cavity 14 and spans the length of cavity 14 from the distal end 18 to the proximate end 16. At distal end 18, screw 32 has a driving end 34 which contacts retainer cup 30. Screw 32 includes an adjustment head 36 at the proximate end which enables the user to adjust screw 32. When a screwdriver (or other adjustment device) is used to turn adjustment head 36 clockwise, screw 32 is driven deeper within cavity 14 and applies more force on retainer cup 30 thereby applying greater force to spring 28 and tip 20. The more force applied to retainer cup 30, the more difficult it is to strike drum surface 22 with enough counterforce to drive tip 20 back within cavity 14 and the more likely tip 20 is to remain in the extended position producing sound at higher tones. At one extreme, the adjustor can apply enough force to tip 20 to prevent it from being retracted into cavity 14.

Conversely, if adjustment head 36 is turned in the counter-clockwise motion, screw 32 is retracted and less force is applied to retainer cup 30, spring 28, and tip 20. With less force being applied to tip 20, it is easier to produce enough counterforce by striking drum surface 22 to retract tip 20 within cavity 14. Striking the drumstick against drum surface 22 when tip 20 is retracted also produces a double echo.

Therefore, when screw 32 applies little or no force to spring 28, the drummer is able to easily retract tip 20 within cavity 14 by simply tapping tip 20 on drum surface 22 or another surface. Striking the drumstick against drum surface 22 in fast, repetitive motions enables tip 20 to remain retracted within cavity 14 and it cannot resume the extended position. When tip 20 remains in this retracted position, the drumstick produces sounds at lower tones than when tip 20 is in the extended position. In order for tip 20 to remain in this retracted position, it is desirable that spring 28 apply as little force as possible to tip 20.

When more force is applied to spring 28 by screw 32, tip 20 protrudes though opening 26 in an extended condition and a great amount of counterforce is needed to push tip 20 back into cavity 14. Requiring greater force to retract tip 20 results in tip 20 remaining in an extended position when striking drum surface 22 and produces sound at higher tones.

In use, the drummer strikes the drumstick against drum surface 22. If screw 32 is adjusted appropriately, the strike pushes tip 20 back into cavity 14 enabling the drummer to strike drum surface 22 a second time producing a lower tone than produced by the first strike. If the drummer desires to only produce sound at higher tones, he rotates adjustment head 36 so that screw 32 applies enough force to tip 20 to keep tip 20 in the extended position when striking drum surface 22. Alternatively, if the drummer wishes to produce sounds of lower tones, the drummer adjusts adjustment head 36 so that screw 32 applies little or no force to spring 28. With little or no force on spring 28, the drummer can strike tip 20 against drum surface 22 to retract tip 20 within cavity 14 and then each successive strike produces sounds at lower tones.

I claim:

1. A drumstick comprising a body with a distal end for striking a surface, the drumstick further comprising a tip that can extend and retract relative to the body when the drumstick strikes the surface.

2. The drumstick according to claim 1 wherein the body is hollow and the tip is retracted within the hollow body.

3. The drumstick according to claim 2 further comprising a spring located within the hollow body that contacts the tip and applies enough force to the tip to push it outside of the hollow body until the tip strikes a surface with enough counterforce to push the tip back into the hollow body.

4. The drumstick according to claim 3 further comprising an adjustor that adjusts the amount of force applied by the spring on the tip.

5. A drumstick comprising:
a) a hollow body with a proximate end and a distal end;
b) a tip at the distal end that is capable of being retracted within the hollow body; and
c) a spring located within the hollow body that supports the tip with a predetermined amount of force.

6. The drumstick according to claim 5 further comprising an adjustor located within the body that adjusts the predetermined amount of force applied to the tip by the spring.

7. The drumstick according to claim 6 further comprising a retainer cup that supports the spring and contacts the adjustor.

8. The drumstick according to claim 6 wherein the adjustor is a screw that can be adjusted by turning a head of the screw at the proximate end of the hollow body.

9. The drumstick according to claim 6 wherein the adjustor can apply enough force to the tip to prevent it from being retracted into the hollow body.

10. The drumstick according to claim 5 wherein the distal end strikes a surface and pushes the tip within the hollow body to produce a first tone.

11. The drumstick according to claim 10 wherein the distal end strikes the surface while the tip is still retracted within the body to produce a second tone.

12. The drumstick according to claim 11 wherein the first tone is higher than the second tone.

13. The drumstick according to claim 10 wherein a double echo is produced when the tip is retracted within the hollow body.

14. A drumstick comprising:
a) a hollow body with a proximate end and a distal end;
b) a removable hollow fitting attached to the distal end that further defines an opening;
c) a tip for contacting a surface located within the removable hollow fitting;
c) a spring located within the distal end of the hollow body that applies force to the tip to force it through the opening defined by the removable fitting; and
d) a retainer cup that contacts the spring.

15. The drumstick according to claim 14 wherein the tip is retracted within the removable hollow fitting thereby placing it in a retracted position when a predetermined amount of force is applied to the tip.

16. The drumstick according to claim 15 wherein a first tone is produced when the tip strikes a surface in the extended position.

17. The drumstick according to claim 16 wherein a second tone is produced when the drumstick strikes a surface when the tip is in a retracted position.

18. The drumstick according to claim 14 further comprising a screw disposed within the hollow body that extends from the proximate end to the distal end where it contacts the retainer cup.

19. The drumstick according to claim 15 wherein the screw is used to apply force to the retainer cup and adjust the amount of force applied to the tip by the spring.
